(19) United States
(12) Patent Application Publication
(10) Pub. No.: US 2016/0191588 A1
(43) Pub. Date: Jun. 30, 2016

(54) PERSONAL BROADCAST SYSTEM

(71) Applicant: InnrCircle, Inc., Sunrise, FL (US)

(72) Inventor: David Shafer, Weston, FL (US)

(21) Appl. No.: 14/985,258

(22) Filed: Dec. 30, 2015

Related U.S. Application Data
(60) Provisional application No. 62/098,021, filed on Dec. 30, 2014.

(51) Int. Cl. H04L 29/06

(52) U.S. Cl. CPC H04L 65/4084; H04L 67/42

(57) ABSTRACT

Systems, methods, and computer-readable media for a personal broadcast system. A client user, such as a celebrity, can initiate a video recording session through an application at the user's device. A group of end users, such as fans, can subscribe to view the video recording session through end user applications at respective user devices. Accordingly, after initiating the video recording session, the client user can send or stream the video recording session to the group of end users having subscribed to view the video recording session. The group of end users can then view the video recording session from the end user applications at the respective user devices.

### CROSS-REFERENCE TO RELATED APPLICATIONS

This application claims the benefit of U.S. Provisional Application No. 62/098,021, filed on Dec. 30, 2014, entitled “PERSONAL BROADCAST SYSTEM”, the content of which is incorporated herein by reference in its entirety.

### BACKGROUND

1. Technical Field

The present disclosure relates to media streaming and more specifically to applications and systems for a personal broadcast system.

2. Introduction

The private and public lives of celebrities and famous personalities are of significant interest to the media and people in general. Any time users open a magazine or newspaper, turn on the television, or browse the Internet, they see news and reports about celebrities driven to feed our appetite for celebrity news and information. Indeed, journalists, businesses, and advertisers often exploit societies' interest in celebrities by focusing on celebrities. Social networks have become extremely popular tools for people to read about celebrities and gain some level of contact with celebrities. For example, fans often subscribe to a celebrity's page on a social network to access messages and information from the celebrity and maintain some level of connection with the celebrity. In many ways, fans are often looking for ways to stay connected with celebrities and gain access to their private lives. Unfortunately, the tools available to fans for accessing a celebrity's private life are greatly limited to static social network pages or news reports.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches disclosed herein can be used by celebrities—as well as other people of interest—to give the public greater access to their private lives. For example, celebrities can share video streams of themselves with their fans. To this end, celebrities can broadcast video streams or recordings of their activities to their fans. Fans can access the stream from a communication device, such as a mobile phone or tablet, and view the feed from a celebrity. This way, fans can stay connected with celebrities and gain a greater glimpse into the celebrity's private life. The celebrities can share their private lives with their fans in real time or through a streamed recording, and allow fans to see them in various events or activities. The celebrity can use a client application to generate and send a feed to their fans, and the fans can access the feed through an end-user application configured to receive selected feeds. The client application of the celebrity can allow the celebrity to generate a profile and manage feeds. On the other hand, the end-user application can allow fans to find, subscribe and access celebrity feeds.

Disclosed are systems, methods, and computer-readable media for a personal broadcast system. A client user, such as a celebrity or any other user interested in broadcasting personal subscription content, can initiate a video recording session through an application at a user's device. A group of end users, such as fans or any other users interested in the client user's personal broadcast, can subscribe to view the content from the video recording session through end user applications at respective user devices. Accordingly, after initiating the video recording session, the client user can send the content to a content delivery network. The content delivery network can then authenticate end users, and stream the content from the video recording session to a group of end users having subscribed to view the content from the video recording session. The group of end users can then view the stream of the video recording session from the end user applications at the respective user devices.

The group of end users can subscribe to specific video streams through the end user applications. In some cases, end users can search video streams or content and select specific streams or content right from the end user applications. The client user (e.g., a celebrity) can advertise personal video streams or content from the application at the client user's device. The client user can also advertise the personal video streams or content from a link on a page, such as a web page, a social network page, a forum, a chat, or any other page or window. The client user can provide the personal video streams or content to the group of end users at a cost. For example, the client user can charge a set fee for each video stream or clip. End users can make the necessary payments to access the video stream or clip through the end user applications. To this end, the end user applications can connect to content delivery network to conduct a transaction.

In some embodiments, the video stream can include an advertisement, such as a logo, a link, an image, a clip, or any other advertising material. For example, the client user can stream the video, and either the application or the content delivery network can insert an advertisement object into the video stream so the receiving end users can view the advertisement object within the video stream. The advertisement object can include an advertisement as previously described.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example network architecture in accordance with an exemplary embodiment;

FIG. 2 illustrates a block diagram of a system for personal broadcasts in accordance with an exemplary embodiment;

FIG. 3 illustrates a block diagram of an example content delivery system in accordance with an exemplary embodiment;

FIG. 4 illustrates a screenshot of a page for sharing personal broadcasts in accordance with an exemplary embodiment;

FIGS. 5, 6, and 7 illustrate flowcharts of methods for broadcasting personal content in accordance with exemplary embodiments; and

FIGS. 8A and 8B illustrate a block diagram of communication systems for sending or receiving personal broadcasts in accordance with exemplary embodiments.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

The present disclosure addresses the need for flexible and efficient solutions for connecting celebrities with fans. For example, a user with a significant social media presence, such as a celebrity, can create personal media broadcasts on his or her mobile device (e.g., smartphone, tablet computer, etc.), and broadcast the personal media broadcast to interested users, such as fans, who have been authorized to receive the broadcast from an associated client application. The user can send the personal media broadcast to a delivery network or system to be published or maintained by the delivery network or system, so interested users can access the content from their client devices. The delivery network or system can enable a mechanism for interested users to purchase or subscribe to the personal media broadcast from an end-user application. The interested users can then be authorized to access the personal media broadcast and continue to access the personal media broadcast from the end-user application. The publishing or broadcasting; purchasing, subscription, and/or authorization; and/or end-user access of the personal media broadcasts can be integrated via an application or network platform, such as a website.

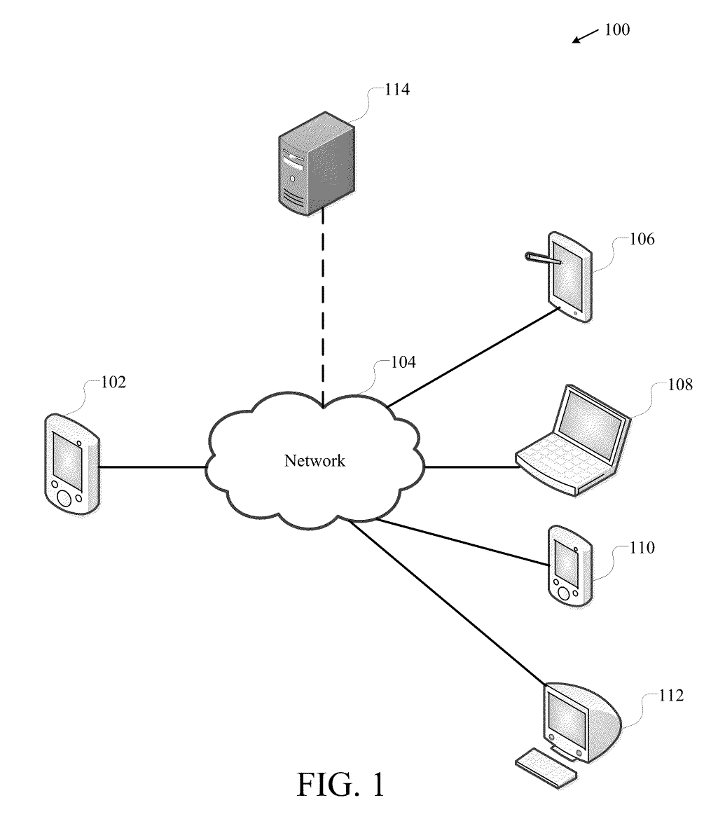

Disclosed herein are systems, method, and computer-readable storage media for personal broadcast systems. A brief description of an example architecture for a personal broadcast system, as illustrated in FIG. 1, is disclosed first herein. A more detailed description of personal broadcast systems and applications will then follow. Variations of personal broadcast systems and concepts shall be described herein as the various embodiments are set forth. The disclosure now turns to FIG. 1.

FIG. 1 illustrates a block diagram of an example network architecture 100 in accordance with an exemplary embodiment. The architecture 100 can be used to perform personal broadcasts between one client user, such as a celebrity, and a group of end users, such as fans or followers. To this end, a client device 102 can record video and/or audio from the client device 102 to generate a media recording or stream, which can include the recorded video and/or audio. The client device 102 can send or stream the media recording or stream via network 104 to selected end users, such as subscribers. The end users can then receive the media recording or stream at the end user devices 106-112.

The client device 102 and end user devices 106-112 can include a device with audio and/or video processing capabilities, such as a laptop, a smartphone, a tablet computer, a gaming system, a smart television, a personal computer, or any other computing device. Moreover, the network 104 can include a public network, such as the Internet; a private network, such as a local area network (LAN); a virtual network, such as a virtual LAN (VLAN); or any combination thereof. Further, the network 104 can include one or more networks and/or sub-networks. In some embodiments, the client device 102 can send or stream the media content without use of network 104. For example, the client device 102 and end user devices 106-112 can establish a point-to-point or ad hoc connection to communicate. However, network 104 is shown for the sake of clarity and explanation purposes.

In some embodiments, the client device 102 can use server 114 to broadcast the media recording or stream to the end user devices 106-112. For example, the server 114 can be implemented to facilitate or coordinate the connection between the client device 102 and end user devices 106-112. As another example, the client device 102 can send or stream the media recording or stream to the server 114 through the network 104, and the server 114 can then provide the media recording or stream to the end user devices 106-112. In some cases, the server 114 can condition the media recording or stream for the end user devices 106-112. For example, the server 114 can condition the media recording or stream by preparing attributes and/or formatting settings for the end user devices 106-112. As another example, the server 114 can condition the media recording or stream by checking the content, formatting the content, testing the content, or modifying the content. In some cases, the server 114 can insert objects into the media recording or stream received from the client device 102. For example, the server 102 can insert an invitational object, such as an advertisement, into the media recording or stream.

After receiving content from the client device 102, the server 114 can also identify proper recipients for the media recording or stream. In other words, the server 114 can determine where the content should be transmitted. The server 114 can identify the recipients based on user subscriptions, policies, settings, rules, payments, or any other identifying attribute. For example, the server 114 can maintain a list of subscriptions and match content received from the client device 102 with the appropriate subscribers or receiving devices. The server 114 can then transmit the content to the appropriate subscribers.

In some cases, the end user devices 106-112 can subscribe to receive the media recording or stream from the client device 102 through an application at the end user devices 106-112. The subscription can then be transmitted from the end user devices 106-112 to the server 114 and/or the client device 102, which can then authenticate or authorize the subscription, and transmit the appropriate content to the end user devices 106-112. For example, the server 114 can maintain subscription and/or security information and match subscriptions with content. The server 114 can thus receive content from the client device 102 and relay the content to the appropriate devices after checking the subscription and/or security information.

The server 114 can also store content received from the client device 102 for transmission or streaming to the end user devices 106-112. Here, the server 114 can store the content at a local or remote storage, such as a local drive or a remote server. Further, in some cases, the server 114 can also conduct or manage payment transactions for subscriptions. For example, the user at the client device 102 can require a specific payment amount for access to the media recording or stream from the client device 102. To this end, the end user devices 106-112 can subscribe to receive the media recording or stream from the client device 102, which can include payment of the amount specified for the media recording or stream. For this, the server 114 and end user devices 106-114 can establish a connection to conduct the payment. In some cases, the end user devices 106-114 can maintain an account at the server 114 which they can fund, through a payment method such as credit card payment, in order to access the media recording or stream. The server 114 can then credit the respective accounts after receipt of payment, and debit the specific amount for the media recording or stream upon agreement by the account holder, based on an agreement input, setting, or preference.

Payments from the end user devices 106-114 can be received or solicited on a subscription basis, a per-transaction basis, a time period, a content amount or type, or a pre-defined fee. Subscriptions can be time based on content based. For example, a subscription can allow access to content over a period of time, such as a week or a month. Alternatively, a subscription can provide access to specific content, such as a clip or a stream. In some cases, the subscription can also contain multiple levels of restriction. For example, the subscription can be content based in the sense that it provides access to a specific item of content, but also time based in the sense that it limits the access to that specific item of content to a period of time, such as a week or a month. Moreover, payments or subscriptions can cover a single item of content, such as a stream, or multiple items of content, such as a bundle of streams. Indeed, payments or subscriptions can cover a portion of content, which can be defined based on the payment amount. The portion of content can be according to a time length, a scene, a chapter, a setting, frames, or a size or amount of data. For example, a payment of a specified amount may yield access to 2 minutes of content or 2 MB of content. Additional content may require additional payments.

In order to conduct the payment transaction, in some cases, the server 114 can include a merchant account. Moreover, the server 114 can communicate with a separate server to conduct any process of the payment transaction, such as the payment, authorization, or verification. For example, the server 114 can communicate with a bank to receive payment for an account and/or subscription.

The specific payment amount for the media recording or stream can be specified by a client user at the client device 102 and stored or retrieved by the server 114 in order to facilitate the transactions. For example, the client user at the client device 102 can define a cost of $2 for every clip or every 3 minutes of content. The server 114 can then maintain those settings and use them to manage subscriptions. This way, the server 114 can determine how much a subscription to a specific content item should be paid by the end user devices 106-112. In other embodiments, the payment amount can be defined at the server 114 by the hosting company or another entity.

Although server 114 is shown as a single server, one of ordinary skill in the art can readily recognize the server 114 can include more than one server. For example, server 114 can include a cluster of servers, or multiple servers either locally or remotely connected. Moreover, the various functionalities described above with respect to server 114 can be performed by one or more servers. For example, storage can be handled by one server, payment can be handled by the same or another server, and media sessions can be managed by the same server as the storage and/or payment server, a different server, or a separate network device, such as a router. Server 114 is simply shown as a single server for the sake of clarity and explanation purposes.

In addition, one of ordinary skill in the art can readily recognize that the client device 102, end user devices 106-112, and/or server 114 can perform more or less functions than those described herein. For example, the client device 102, end user devices 106-112, and/or server 114 can communicate with a social network to share content or initiate communication sessions. Moreover, while the architecture 100 is illustrated as including a server 114, other configurations are also contemplated herein. For example, in some embodiments, the architecture 100 can include multiple servers, multiple networks, or a cloud environment. As another example, in other embodiments, the server 114 may be optional. Here, the client device 102 may establish a media session with the end user devices 106-112 using a direct connection (e.g., point-to-point).

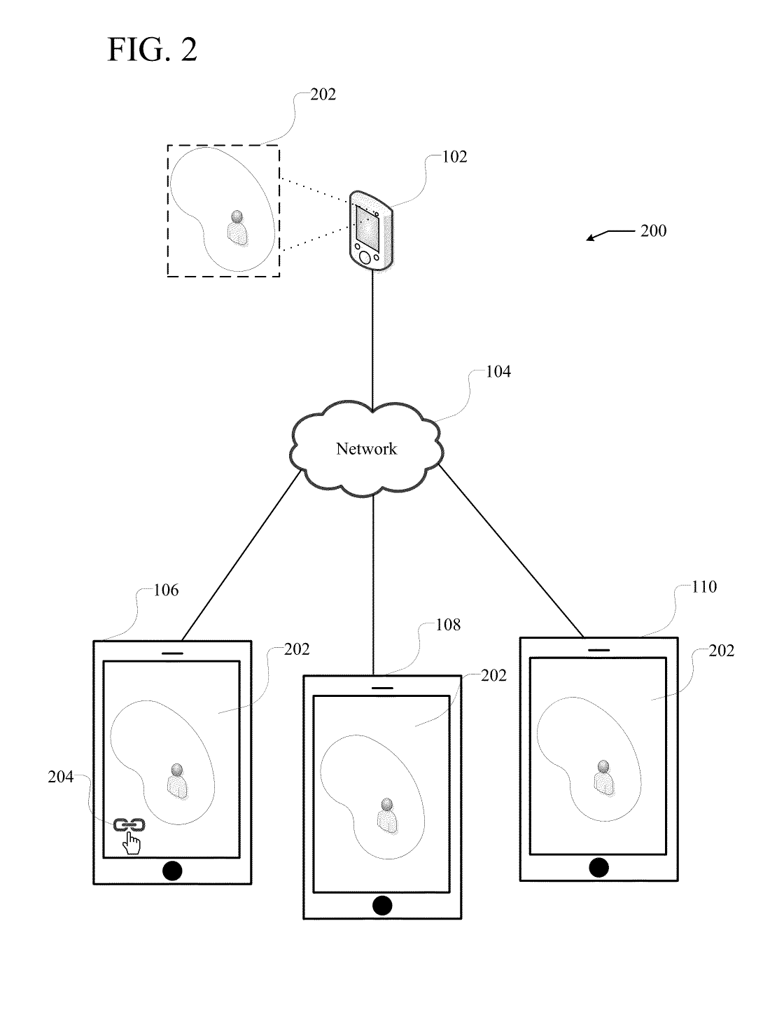

FIG. 2 illustrates a block diagram of a system 200 for personal broadcasts in accordance with an exemplary embodiment. The client device 102 can send or stream content from a media session 202 to the end user devices 106-110 via network 104. The content from the media session 202 can include content captured by one or more recording components associated with the client device 102, such as a camera or a microphone. For example, the content from the media session 202 can include video, audio, text, photos, or other media content captured by the client device 102. The content from the media session 202 can be a live media feed or a pre-recorded media session. In some embodiments, the recording component can be integrated with the client device 102, attached to the client device 102, or remotely coupled to the client device 102.

In some embodiments, a client user at the client device 102 can initiate the media session 202 for streaming to the end user devices 106-110 through an application at the client device 102. For example, the client user can login to the application on the client device 102 and initiate the media session 202 through the application. The application can then activate the recording components to begin recording the content for the media session 202. For example, the application can activate a camera and microphone at the client device 102 to start recording video and audio content for the media session 202. The camera can capture video content within the range of view of the camera, and the microphone can record audio it detects. For example, if the client user is swimming in a pool, the client user can begin a streaming session through the client device 102 to capture a clip of the client user swimming in the pool and send or stream the clip to the end user devices 106-110.

End users at the end user devices 106-110 can receive the media session 202, captured at the client device 102, through the end user devices 106-110. Here, the end users can request the media session 202 through the end user devices 106-110, which can receive and present the media session 202 for the end users. In some embodiments, the end users can request the media session 202 through an end user application at the end user devices 106-110. The end user application, in some cases, can be an end user version of the client application used at the client device 102 to capture and send the media session 202. The end users can login to the end user application from the end user devices 106-110 and request the media session 202 from the end user application. The end user devices 106-110 can then receive the media session 202 and present it for the end users through the end user application used to request the media session 202 and/or a separate window/interface.

In some embodiments, in order to receive the media session 202, the end users at the end user devices 106-110 can subscribe to the specific media session desired. For example, the end users can search or locate the specific media session they wish to access, and select the media session or a corresponding link/object to initiate a subscription process. The subscription process can allow the end users to request the media session at the end user devices 106-110. In some cases, the subscription process can include a payment process. For example, the media session 202 can be configured to require a payment of a specified amount from end users in order to enable access to the media session 202. Thus, the end users at the end user devices 106-110 can make the necessary payment to receive the media session 202 as part of the subscription process.

During the subscription process, the end users at the end user devices 106-110 can enter their payment information and authorize the necessary charge to complete the subscription. The end user devices 106-110 can then communicate with the client device 102 and/or a separate server, such as a subscription server or a bank server, to execute the transaction. In some cases, a server can verify the payment and allow access to the media session 202 once payment is verified. The access after verification can be provided by, for example, disabling a restriction setting, relaying the media session 202 to the appropriate end user device, coordinating a stream or transmission of the media session 202, or directing the media session 202 from the client device 102 or a content server to be sent to the appropriate end user device based on the subscription.

In some embodiments, the media session 202 can be modified for presentation at the end user devices 106-110. For example, an object 204 can be inserted into the media session 202 for presentation at one or more end user devices 106-110. The object 204 can include content, such as video, audio, images, media, or text. In some cases, the object 204 can be an advertisement inserted into the media session 202. For example, the object 204 can be a logo and/or a link inserted into the media session 202 to invite or entice end users to something. The object 204 can be selected based on the client user at the client device 102 streaming content, that client user's account or settings, the application used for the media session streaming, a third-party sponsor or advertiser, an affiliated company, a brand, etc. In some cases, the object 204 can be selected based on a context of the media session 202. For example, if the media session 202 includes a client user swimming by the pool, the object 204 can be selected based on a relationship of the object 204 to swimming or pools. As another example, if the media session 202 involves a client user showing a car, the object 204 can be related to the car, such as the auto maker's logo.

This sharing of content can allow a client user to share recorded clips or segments to a group of interested end users. For example, a celebrity can share portions of the celebrity's private or personal life by allowing fans to subscribe to clips or segments recorded by the celebrity and receive the clips or segments from the celebrity. To illustrate, a celebrity can use the client device 102 to record n minutes or hours of the celebrity hanging out by the pool. The celebrity can then publish the recorded content through a sharing application. Fans can then access the recorded content through the sharing application on their end user devices 106-110. For example, the fans can subscribe to the recorded content published by the celebrity to view the content. The fans can pay a subscription amount to view the recorded content based on a price defined by the celebrity and/or any other entity. This way, the celebrity can sell broadcasts of the celebrity's private or personal life to fans eager to stay connected with the celebrity and view sessions created by the celebrity. In some cases, the celebrity can coordinate the sessions generated with advertising used in the sessions to invite the end user to consume a product or perform a conversion action.

The celebrity can create multiple sessions and publish the sessions for subscribing fans to access. The sessions can be accessed by the fans in real time, near real time, or based on a previous recording. The celebrity can publish the session within the same application used by the fans to access the celebrity's session from the end user devices 106-110. However, in some cases, the fans can also access the session through a link or address provided on a page, such as a web page or a social network page. For example, the celebrity can post a link to a current session (or a pre-recorded session) on the celebrity's home or profile page in a social network, where fans can view the link and access the session posted by the celebrity. The fans can use the link to view the media session through an application on their device or directly from their web browser.

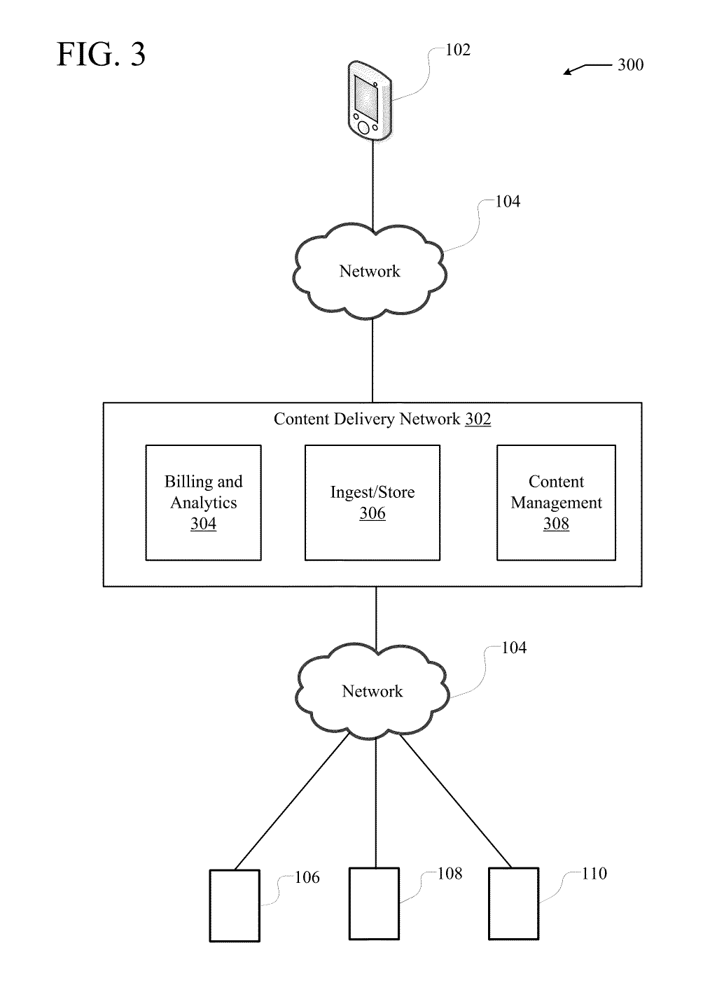

FIG. 3 illustrates a block diagram of an example content delivery system 300 in accordance with an exemplary embodiment. Client device 102 can communicate with content delivery network 302 via network 104. The content delivery network 302 can communicate with the end user devices 106-110 via network 104. The content delivery network 302 can host and provision content services to the client device 102 and end user devices 106-110.

In some embodiments, the client device 102 can prepare content to be shared, streamed, or broadcast to end user devices 106-110. For example, the client user at the client device 102 can initiate a video and/or audio recording session at the client device 102 to generate content for access by the end user devices 106-110. The client device 102 can use a camera, a microphone, a video or audio application, or other input and recording components to generate and prepare the content.

Once the client device 102 has completed the preparation of the content, the client user at the client device 102 can select the method of uploading the content to the content delivery network 302. For example, the client user can indicate what method or preferences should be used by the content delivery network 302 for ingesting the content prepared by the client device 102. The client device 102 can send the prepared content, which can include media recorded at the client device 102, to the content delivery network 302. The client device 102 and/or content delivery network 302 can also authenticate the content ingest or upload. For example, the client device 102 can provide a password or passphrase to authenticate the account and/or ingest. The content delivery network 302 can check and authenticate the content, verify the account, or request further authentication information for further validation. The content can also be validated using one or more validation mechanisms, such as using a checksum or a hash function.

The content delivery network 302 can ingest the content and centrally store the content for delivery to end users via the ingest/store component 306. The ingest/store component 306 can include software and hardware for ingesting and storing content. For example, the ingest/store component 306 can include one or more servers, storage drives, databases, or clusters. In some embodiments, the ingest/store component 306 can be a server configured to ingest and store content. Here, the server can include storage space to store the content, such as an array of hard drives, and/or connect to a remote storage repository to store the content it ingests. In other embodiments, the ingest/store component 306 can include a server cluster or datacenter, configured to store content ingested by the content delivery network 302.

The content delivery network 302 can also include a content management component 308. The content management component 308 can manage content requests from the end user devices 106-110. For example, when client devices 106-110 request content from the content delivery network 302, the content management component 308 can receive and process each request. The content management component 308 can request the relevant content from the ingest/store component 306 based on each request. The content management component 308 can then deliver the requested content to the end user devices 106-110.

Further, the content management component 308 can include one or more content management modules, such as software and/or hardware modules. In some cases, the content management component 308 can be a content management server configured to process content requests and deliver content from the ingest/store component 306. In other cases, the content management component 308 can include multiple content management servers, such as a cluster of servers. Here, each content request and delivery can be managed by one or more servers selected based on one or more factors, such as transmission or path cost, proximity, available resources, scheduling constraints, priorities, preferences, assignments, available resources, etc. For example, when processing requests and serving content, the content management component 308 can identify a nearest server from the content delivery network 302 relative to the requesting end user, and select that nearest server to deliver the content and/or handle the content request. The nearest server can refer to the nearest server in terms of distance, hops, or networks, for example.

The content management component 308 can also cache the requested content for future access. For example, the content management component 308 can cache the requested content on an edge server in the content delivery network 302. In some cases, the content management component 308 can identify the nearest edge server in the content delivery network 302 relative to a specific end user device, and cache the requested content for that specific end user device at the nearest edge server.

Subsequent content requests can be handled by a same server from the content management component 308 as previous, associated request. For example, if server A handles a content request from end user device 106, subsequent content requests from end user device 106 can be handled again by server A. However, in other cases, subsequent requests can alternatively be handled by other servers. For example, for each request or group of requests, the content management component 308 can make a new assessment as to which server should handle the request or group of requests based on the one or more factors previously described. This can result in a different server being selected to handle a subsequent request, particularly if a change has occurred since the previous request.

The billing and analytics component 304 can process transactions, perform account tracking, maintenance, provisioning, reporting, etc. In some cases, records of download transactions can be handled by the billing and analytics component 304. The billing and analytics component 304 can generate and store logs, and perform account and transaction analytics. The billing and analytics component 304 can perform billing transactions, including payments, subscriptions, and registrations. The billing and analytics component 304 can verify or authenticate payments, and communicate with other entities, such as banks, as part of the billing process. In some cases, the billing and analytics component 304 can communicate with the content management component 308 in order to verify and manage payments and subscriptions for delivering content. The billing and analytics component 304 can include one or more servers configured to perform billing, accounting, analytics, and/or account tracking. In some cases, the billing and analytics component 304 can be a central datacenter having multiple servers for processing billing, analytics, or accounts.

The content delivery network 302 can include more or less components than those illustrated in FIG. 3. For example, the content delivery network 302 can include separate or combined servers, databases, or modules for content filtering, content formatting, advertising, content matching, user profiles, scheduling, or other content services. Moreover, the content delivery network 302 can provide a variety of content services. For example, the content delivery network 302 can provide access to “behind-the-scenes” content from celebrities, personal broadcasts, or other customer-generated content. However, the examples provided above are for clarity and explanation purposes.

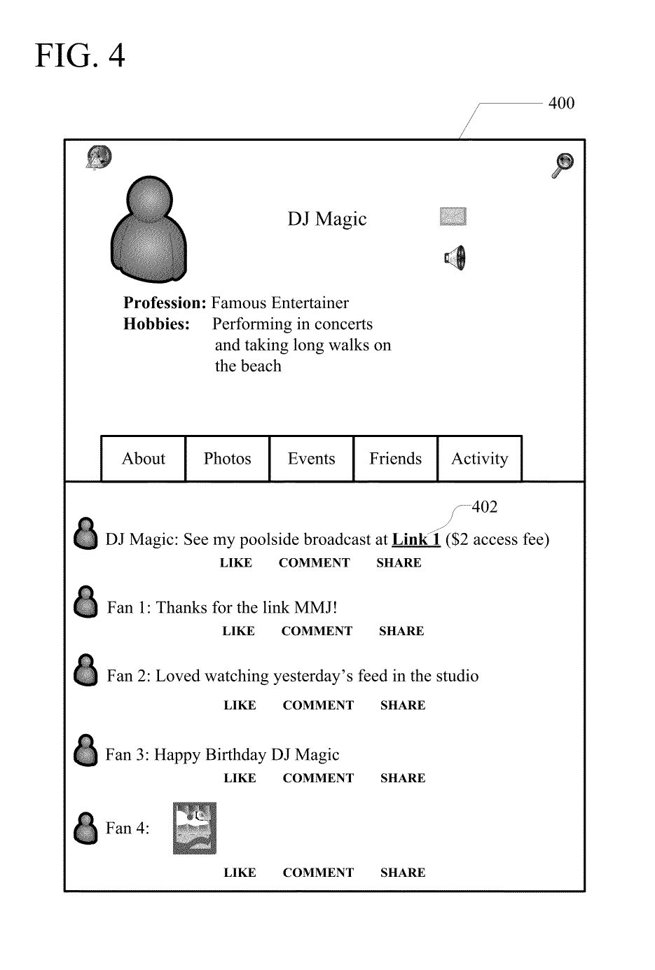

FIG. 4 illustrates a screenshot of a page 400 for sharing a personal broadcast in accordance with an exemplary embodiment. The page 400 can be a web page, a blog, a social network page, a discussion forum page, a messaging page, or any other type of page or window for sharing content or communicating with other users. For example, the page 400 can be a celebrity's public page in a social network. The celebrity can share a link 402 to a personal broadcast session in the page 400, where users can learn about the sessions shared by the celebrity. The link 402 can include an address or reference to the session, which can be user-selectable in some cases. When providing the link 402, the celebrity can also provide additional details about the session. For example, the celebrity can provide a description of the type or context of the session along with the link 402, to better inform users about the session.

The celebrity can also provide additional details regarding how to subscribe to the session, the cost of subscribing, payment methods, time length of the session, or any other details. For example, the celebrity can provide the link 402 with a short description specifying that the session shows the celebrity by the pool and can be accessed for $2. The users can click on the link to access the session or copy the address and enter it in a browser or application window. The users can also share the link 402 with other users through their own page.

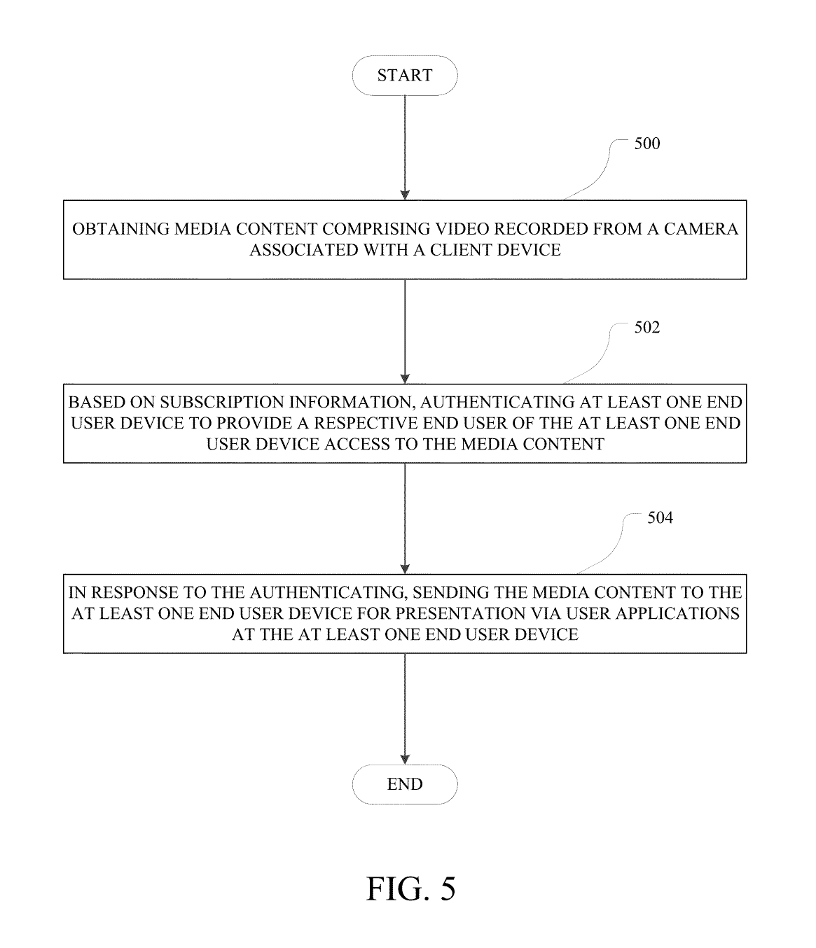

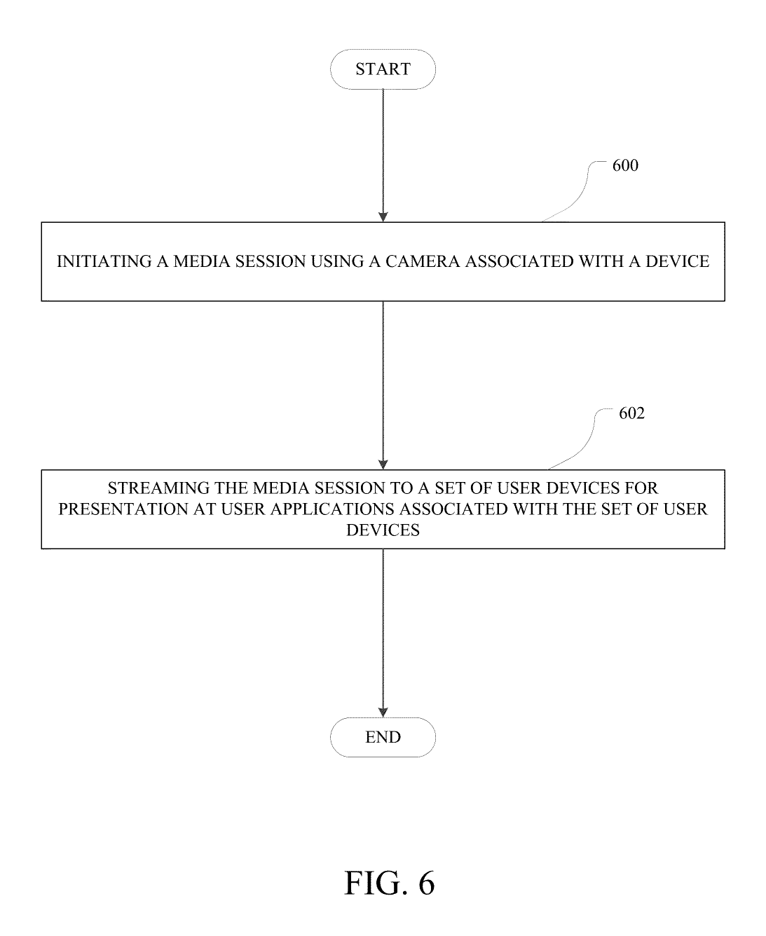

Having disclosed some basic system components and concepts, the disclosure now turns to FIGS. 5, 6, and 7, which show methods in accordance with exemplary embodiments. For the sake of clarity, the methods are described in terms of a client device 102 and end user devices 106-112, as shown in FIG. 1, as well as a content delivery network 302, as shown in FIG. 3, configured to practice the various steps. The steps outlined herein are exemplary and can be implemented in any combination thereof, including combinations that exclude, add, or modify certain steps.

At step 500, the content delivery network 302 obtains media content. The media content can include video recorded from a camera or recording device. The camera or recording device can be associated with a client device. For example, the camera or recording device can be attached to the client device or integrated into the client device. The content delivery network 302 can receive the media content from a client device such as client device 102 illustrated in FIG. 1. The client device can initiate a recording session to capture the video content at the client device. The client device can also capture audio content through a microphone, or generate text or image content via an input device at the client device. The client device can record and prepare the media content, and transmit the media content to the content delivery network 302. The content delivery network 302 can ingest the media content and store the content for delivery to end users.

At step 502, based on subscription information, the content delivery network 302 can authenticate end user devices to provide respective end users of the end user devices access to the media content. For example, the content delivery network 302 can maintain user subscriptions to content. Thus, the content delivery network 302 can analyze the media content and determine whether particular end users have subscribed to the media content. The content delivery network 302 can determine if payment has been provided for the content and if the end users are permitted to access the content based on specific subscriptions completed. The content delivery network 302 can identify which users are subscribed to access the media content or which users should be granted access to the media content, and accordingly grant access to the media content to the pertinent users.

At step 504, in response to the authenticating, the content delivery network 302 can send the media content the end user devices for presentation via user applications at the end user devices. The content delivery network 302 can limit the end user devices that it sends the media content to those end user devices that have been granted access based on subscriptions, payments, or permission settings. In some embodiments, the content delivery network 302 can send the media content to the end user devices automatically upon authenticating the end user devices. In other embodiments, the content delivery network 302 can send the media content in response to a triggering event, such as an end user request, a schedule, a transaction, or a user action.

The content delivery network 302 can send the media content to the end user devices via a network, such as the Internet. In some cases, the content delivery network 302 can stream the media content to the specific end user devices having access to the media content. In other cases, the content delivery network 302 can download the content to the end user devices or broadcast the content to the end user devices. Moreover, the content delivery network 302 can modify the media content by changing the formatting, tags, attributes, metadata, or content. For example, the content delivery network 302 can insert objects, such as advertisements, into the media content and send the media content with the added objects to the end user devices.

At step 600, the client device 102 initiates a media session using a camera associated with the client device 102. The client device 102 can also use any other input device associated with the client device 102, such as a microphone to record audio, an LED light to provide proper lighting or flash, and so forth. The media session can be a video session based on video recorded through the camera. The media session can also include other type of media content, such as audio, image, or text. For example, the media session can include an advertisement, such as a logo, inserted into the content from the media session.

The client device 102 can initiate the media session via a particular application at the client device 102. The application can initiate the media session, obtain recorded content from the camera and any other input devices, and prepare the media session for streaming to users. The application can have a corresponding user application, which can be another version of the application that is used by end users to subscribe to the media session, and access the media session from end user devices.

At step 602, the client device 102 then sends the media session to a set of user devices for presentation at user applications associated with the set of user devices. The set of user devices can be selected based on user subscriptions to the media session. For example, the client device 102 and/or a separate server can maintain a database or list of subscriptions to content (i.e., media sessions) for determining which specific user devices are subscribed to a particular media session. The client device 102 and/or server can then send the media session to those user devices associated with users that are subscribed to receive or access the media session.

In some embodiments, a celebrity can use the client device 102 to initiate a personal media session where the celebrity can provide fans with video access to the celebrity's personal moments or life. Fans can use end user devices, such as end user devices 106-112, to subscribe to the personal media session and access the personal media session from their device. This way, the fans can connect with the celebrity, and the celebrity can obtain payment for sharing personal video content. The celebrity can share content at different times and in different contexts. For example, the celebrity can broadcast a session of the celebrity hanging out back stage, and later initiate a different session of the celebrity hanging out with friends by the beach.

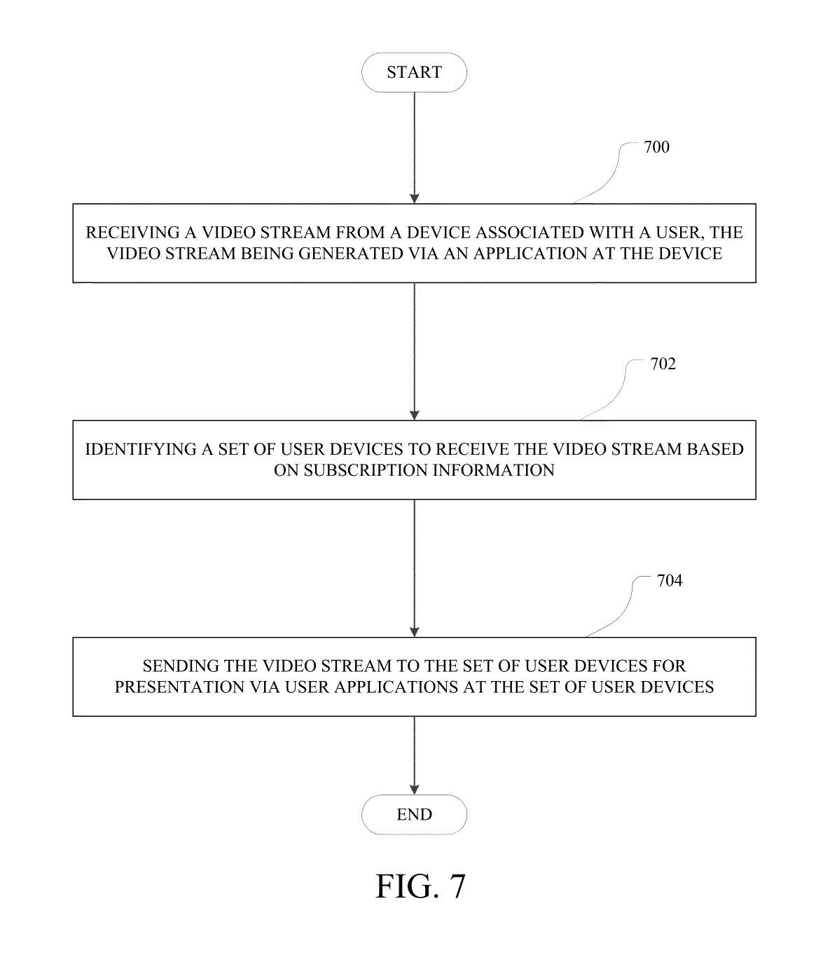

Referring to the example method embodiment illustrated in FIG. 7, at step 700 the server 114 can receive a video stream from a client device 102 associated with a user. In some embodiments, the user can be a celebrity selling or sharing personal broadcasts to fans or other users. Here, the celebrity can sell the personal broadcasts through a subscription mechanism, for example. The celebrity can generate the video stream via an application at the client device 102. The application can be an application for sharing personal broadcasts. To this end, the celebrity can setup and publish the personal broadcast or video stream from the application at the client device 102, and fans or users can then subscribe and access the personal broadcast or video stream from client applications at the end user devices 106-112. The server 114 can receive or store the video stream or any other media content from the client device 102, verify subscriptions, and/or relay or forward the video stream or any other media content to the end user devices 106-112.

At step 702, the server 114 can identify end user devices 106-112 to receive the video stream based on subscription information. The subscription information can indicate what users or devices are subscribed to access the video stream and should receive the video stream. In some cases, the server 114 can maintain subscription information to authorize access or forward requests. In other cases, the server 114 can retrieve the subscription information from a remote device or receive a subscription verification from a separate device.

At step 704, the server 114 can send the video stream to the identified end user devices 106-112 for presentation via user applications at the end user devices 106-112. The server 114 can forward, relay, or stream the video stream to the identified end user devices 106-112. The server 114 can automatically send the video stream to the end user devices 106-112 upon receipt from the client device 102 and/or verification of subscription or access permissions. However, in other embodiments, the server 114 can send the video stream to the end user devices 106-112 in response to a triggering event, such as a request from the end user devices 106-112, a request from the client device 102, a subscription request or completion, a schedule, a payment receipt, or any other triggering event.

In some embodiments, the server 114 can prepare or condition the video stream for presentation at the identified end user devices 106-112. To this end, the server 114 can modify content attributes or preferences, formatting, or content. For example, the server 114 can compress the content for transmission or modify the content to include additional features. In some cases, the server 114 can modify the video stream by inserting content, such as advertising or invitational content. In other cases, the server 114 can maintain multiple versions of the video content and select a specific version to send to the end user devices 106-112 based on one or more factors, such as payment amount, subscription preferences, device capabilities, presentation preferences, and so forth.

### Example Devices

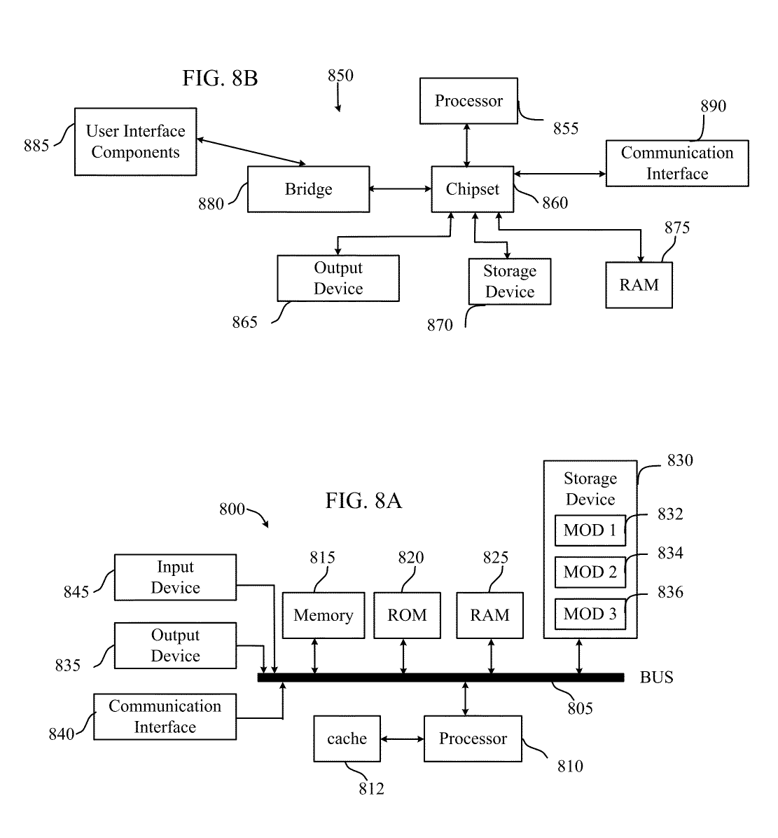

FIG. 8A and FIG. 8B illustrate example system embodiments. The more appropriate embodiment will be apparent to those of ordinary skill in the art when practicing the present technology. Persons of ordinary skill in the art will also readily appreciate that other system embodiments are possible.

FIG. 8A illustrates a conventional system bus computing system architecture 800 wherein the components of the system are in electrical communication with each other using a bus 805. Exemplary system 800 includes a processing unit (CPU or processor) 810 and a system bus 805 that couples various system components including the system memory 815, such as read only memory (ROM) 870 and random access memory (RAM) 875, to the processor 810. The system 800 can include a cache of high-speed memory connected directly with, in close proximity to, or integrated as part of the processor 810. The system 800 can copy data from the memory 815 and/or the storage device 830 to the cache 817 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 837, module 7 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 875, read only memory (ROM) 870, and hybrids thereof.

The storage device 830 can include software modules 837, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates an example computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output 865, such as a display, and can read and write information to storage device 870, which can include magnetic media, and solid state media, for example. Chipset 860 can also read data from and write data to RAM 875. A bridge 860 for interfacing with a variety of user interface components 865 can be provided for interfacing with chipset 860. Such user interface components 865 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 860 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 865 and execute appropriate functions, such as browsing functions by interpreting these inputs using processor 855.

It can be appreciated that example systems 800 and 850 can have more than one processor 810 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

We claim:

1. A method comprising:
obtaining, via a server from a client device, media content recorded from a camera associated with the client device;
receiving, via the server from the client device, a request to publish the media content recorded from the camera for access by authorized end users from respective client devices;
based on subscription information, authenticating, via the server, at least one end user device to provide at least one respective end user access to the media content via the server;
in response to the authenticating, sending, via the server, the media content to the at least one end user device for presentation via an associated user application at the at least one end user device.

2. The method of claim 1, wherein the media content comprises a media recording session recorded by a celebrity user, and wherein the at least one end user device is associated with at least one end user having subscribed to view media content associated with the media recording session of the celebrity from respective end user devices through the associated user application configured to receive media content associated with media recording sessions by the celebrity.

3. The method of claim 1, wherein the media content comprises a media feed, the media feed comprising at least one of video, audio, and an invitational content item.

4. The method of claim 3, wherein the invitational content item comprises at least one of a logo, a link, a design, text, or an image.

5. The method of claim 1, further comprising establishing, via the server, a celebrity account for streaming the media content to end users.

6. The method of claim 5, wherein the celebrity account is configured to receive payment from end users for access to the media content based on a user subscription.

7. The method of claim 6, wherein the payment is based on a pay-per-view scheme, the payment being received from the user applications.

8. The method of claim 1, wherein a time length of the media content is based on at least one of a pre-defined setting or an input received at a client application, and wherein the server comprises a content delivery network.

9. The method of claim 8, wherein the media content automatically terminates after reaching the time length.

10. The method of claim 1, further comprising sending an indication of an availability of the media content to end user devices for presentation at the end user devices.

11. A system comprising:
a processor; and
a computer-readable storage medium having stored therein instructions which, when executed by the processor, cause the processor to perform operations comprising:
receiving a video stream from a device associated with a user, the video stream being generated via an application at the device;
identifying a set of user devices to receive the video stream based on subscription information, the subscription information indicating that the set of user devices are subscribed to access the video stream;
sending, via the system, the video stream to the set of user devices for presentation via user applications at the set of user devices.

12. The system of claim 11, further comprising inserting an advertisement into the video stream prior to sending the video stream to the set of user devices.

13. The system of claim 12, wherein the advertisement comprises at least one of a logo, a link, a product description, a brand description, or an image.

14. The system of claim 11, wherein the user is a celebrity and wherein the set of user devices are associated with people having subscribed to receive the video stream from the celebrity.

15. The method of claim 11, further comprising prior to sending the video stream, verifying at least one of a user subscription or a payment for receiving the video stream.

16. A non-transitory computer-readable storage medium having stored therein instructions which, when executed by a processor, cause the processor to perform operations comprising:
receiving, via a user application at a client device, a request to subscribe to a video stream associated with a user, the video stream being generated via an application at a device associated with the user;
receiving, via the user application at the client device, a request to access the video stream through the user application at the client device; and
in response to the request to subscribe to the video stream and the request to access the video stream, receiving the video stream for presentation via the user application at the client device.

17. The non-transitory computer-readable storage medium of claim 16, wherein the video stream is received from at least one of a server or the application at the device associated with the user.

18. The non-transitory computer-readable storage medium of claim 16, wherein the user is a celebrity and the subscription authorizes a subscriber to access the video stream of the celebrity through the user application, the subscription being based on at least one of a payment or an agreement.

19. The non-transitory computer-readable storage medium of claim 16, wherein the video stream comprises an advertisement inserted into the video stream for presentation within the video stream, the advertisement comprising at least one of a link, a logo, or an image.

20. The non-transitory computer-readable storage medium of claim 12, storing additional instructions which, when executed by the processor, result in further operations comprising:
receiving, via the user application, a request to search for the video stream from a list of video streams associated with at least one celebrity;
based on the request, identifying the video stream; and
presenting a search result comprising the video stream, wherein the search result is user-selectable to allow selection for initiating at least one of the subscription or playback of the video stream.
